(19) United States
(12) Patent Application Publication
(10) Pub. No.: US 2024/0246554 A1
(43) Pub. Date: Jul. 25, 2024

(54) VEHICLE AND CONTROL METHOD THEREOF

(71) Applicants: Hyundai Motor Company, Seoul (KR); Kia Corporation, Seoul (KR)

(72) Inventor: Youngkee Kim, Seoul (KR)

(21) Appl. No.: 18/363,862

(22) Filed: Aug. 2, 2023

(30) Foreign Application Priority Data
Jan. 19, 2023 (KR) 10-2023-0007868

(51) Int. Cl. B60W 50/14; B60T 7/12

(52) U.S. Cl. CPC B60W 50/14; B60T 7/12

(57) ABSTRACT

In an embodiment of a vehicle and a control method thereof, the vehicle can include a switch configured to generate a signal for the vehicle to perform emergency stopping during driving, and a driving controller configured to control the vehicle to perform the emergency stopping by the signal generated by the switch. The driving controller can be configured to control the vehicle to perform the emergency stopping in response to the signal being generated for a first input to the switch and in response to the signal being generated after a period of time for a second input to the switch, wherein the second input is different from the first input.

### CROSS-REFERENCE TO RELATED APPLICATIONS

This application claims the benefit of Korean Patent Application No. 10-2023-0007868, filed on Jan. 19, 2023, which application is hereby incorporated herein by reference.

### TECHNICAL FIELD

The disclosure relates to a vehicle that can perform an emergency stop.

### BACKGROUND

While driving, it may happen that a driver is unconscious or unable to drive normally due to any other reason. In this case, conventionally, a vehicle's emergency stop is performed by a controller of a vehicle, after confirming that a driver does not hold a steering wheel or is not looking ahead.

However, even though a driver is not able to drive normally due to unconsciousness or other reasons, when the driver unconsciously touches a steering wheel, a vehicle controller may determine that an emergency does not persist and not perform an emergency stop. Also, when a driver temporarily looks ahead while unconscious, the vehicle controller may not perform an emergency stop.

In the event of emergency as described above, a vehicle may not normally perform an emergency stop, even when another occupant exists, which is mostly because a switch for emergency stop is not provided in a vehicle. In addition, when another occupant turns off a start switch to stop a vehicle during driving, the vehicle may not be stably emergency stopped, increasing the risk of accidents.

Japanese Patent Publication No. 2015-174474 (Oct. 5, 2015) and Japanese Utility Model Registration No. 3231189 (Feb. 25, 2021) are related to subject matter discussed herein.

### SUMMARY

An embodiment can relate to a vehicle and a control method thereof, and more particularly, to a vehicle and a control method thereof that can perform an emergency stop when a driver is unconscious or unable to drive normally for any other reason.

In an embodiment, a vehicle and a control method thereof can urgently stop a vehicle in an event of emergency to a driver, when the driver and a passenger exist in the vehicle.

Embodiments of the disclosure will be set forth in part in the description which follows and, in part, can be obvious from the description, or can be learned by practice of the disclosure.

In accordance with an embodiment of the disclosure, a vehicle can include a switch and a driving controller. The switch can be configured to generate a signal for the vehicle to perform an emergency stop during driving. The driving controller can be configured to control the vehicle to perform the emergency stop by the signal generated in the switch. The driving controller can be configured to control the vehicle to perform the emergency stop, in response to a signal for a first input being generated and a signal for a second input different from the first input being generated after a predetermined period of time in the switch.

The driving controller can be configured to control the vehicle to perform the emergency stop, in response to the first input to the switch lasting longer than a first programmed period of time and the second input to the switch lasting longer than a second programmed period of time.

The vehicle can further include an input-output device configured to display information about the vehicle.

The driving controller can be configured to control the input-output device to display at least one of notification or warning for notifying that the vehicle is to be emergency stopped, in response to the signal for the first input being generated in the switch.

The driving controller can be configured to control the input-output device to provide guidance on the second input, in response to the signal for the first input being generated in the switch.

The switch can be configured to move in one direction, move in another direction, and stop to generate the signal.

The signal for the first input can be generated in response to the switch moving in the one direction, and the signal for the second input can be generated in response to the switch moving in the other direction.

The switch can be an electronic parking brake switch for preventing the vehicle from moving in a parked state.

The driving controller can be configured to confirm whether a device included in the vehicle is not operated after the first input to the switch lasts for a predetermined period of time, and control the vehicle to perform the emergency stop, in response to the second input to the switch lasting for a predetermined period of time.

The driving controller can be configured to control the vehicle not to perform the emergency stop, in response to a device included in the vehicle being operated between the first input and the second input.

The driving controller can be configured to perform an acceleration limit control after the first input.

In accordance with an embodiment of the disclosure, a control method of a vehicle can include confirming whether a first input to a switch is made while the vehicle is driving. In an embodiment, the control method can include generating a notification and/or warning for emergency stop, in response to the first input to the switch being made. In an embodiment, the control method can include confirming whether a second input different from the first input is made to the switch. And in an embodiment, the control method can include, in response to the second input to the switch being made, generating a signal for the vehicle to perform an emergency stop in a driving controller.

The confirming of whether the first input is made can confirm whether the first input to the switch lasts longer than a predetermined period of time.

The confirming of whether the second input is made can confirm whether the second input to the switch lasts longer than a predetermined period of time.

The control method can further include generating the notification and/or the warning, and confirming whether a device included in the vehicle is not operated, and the confirming of whether the second input is made can confirm whether the second input is made, in response to the device included in the vehicle being not operated.

The control method can further include providing guidance for operating the switch, in response to the device included in the vehicle not being operated, and the second input can be made after providing the guidance.

Performing the emergency stop can be stopped in response to the device included in the vehicle being operated.

The switch can be configured to move in one direction, move in another direction, and stop to generate the signal.

A signal for the first input can be generated in response to the switch moving in the one direction, and a signal for the second input can be generated in response to the switch moving in the other direction.

The switch can be an electronic parking brake switch for preventing the vehicle from moving in a parked state.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a diagram illustrating an interior of a vehicle according to an embodiment;

FIG. 2 is a block diagram illustrating an emergency stop apparatus of a vehicle according to an embodiment;

FIG. 3 illustrating a graph comparing values of deceleration command values for automatic and manual emergency stop when a vehicle is emergency stopped according to an embodiment; and

FIG. 4 is a flowchart illustrating a control method for emergency stop of a vehicle according to an embodiment.

### DETAILED DESCRIPTION OF ILLUSTRATIVE EMBODIMENTS

Hereinafter, embodiments will be described in detail with reference to the accompanying drawings. The embodiments disclosed below are illustrative of technical ideas of the disclosure, and those skilled in the art can appreciate that various modifications, changes, and substitutions can be made without departing from the essential characteristics thereof. Parts irrelevant to description can be omitted in the drawings in order to clearly explain embodiments. In the drawings, a width, length, thickness, and the like of constituent components can be exaggerated for convenience. Like reference numerals throughout the specification denote like elements.

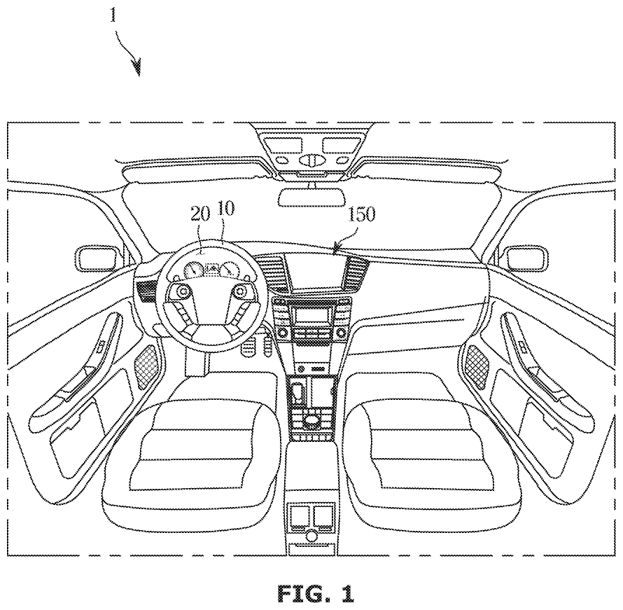

A vehicle 1 according to an embodiment is described with reference to FIG. 1. The vehicle 1 includes a steering wheel 10, a display 20, and an input-output device (I/O device) 150. The display 20 and the I/O device 150 can be located on a dashboard inside the vehicle 1, and the display 20 can be referred to as a cluster. The steering wheel 10 can be operated by a user to change a driving direction.

Seats can include a driver's seat, a passenger seat for a front occupant to sit on, and a rear seat located at a rear of the vehicle 1. The display 20 can be implemented digitally and/or in an analog manner.

A center fascia can be positioned between the driver's seat and the passenger seat in the dashboard, and can include an audio device, an air-conditioning device, and the I/O device 150, for example. An air vent, a cigarette lighter jack, a plurality of buttons, and the like, can be located in the center fascia, for example.

The vehicle 1 can include the I/O device 150 receiving operation commands of various functions as input, and an organic light-emitting diode (OLED) panel or a liquid crystal display (LCD) panel can be implemented in the I/O device 150.

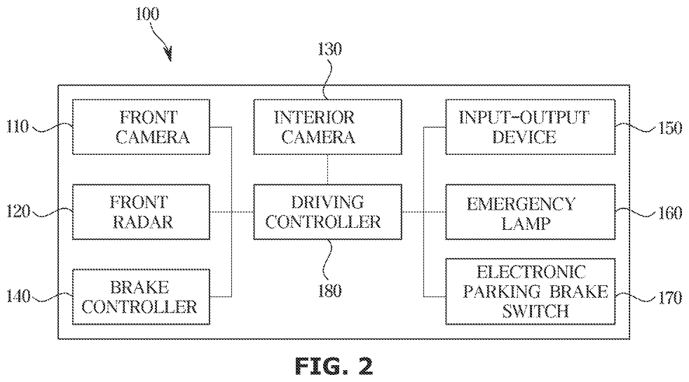

The I/O device 150 can include buttons for operating a variety of functions and changing setting values of the various functions, and also can be implemented as a touch screen. The I/O device 150 can optionally receive an input of either a manual driving mode or an autonomous driving mode while a driver is driving the vehicle 1. When the autonomous driving mode is selected, the vehicle 1 can transmit an input signal of the autonomous driving mode to a driving controller 180 (shown in FIG. 2).

The driving controller 180 can serve to distribute signals to various devices of the vehicle 1, and to transmit a signal for a control command of one device to other devices.

Also, the I/O device 150 can perform a navigation function, a digital multimedia broadcasting (DMB) function, an audio function, a video function, display road environment information, display driving information, and the like, or any combination thereof, even in the autonomous driving mode, for example.

Furthermore, as a safety device of the vehicle 1, an airbag device for safety of occupants including a driver in an event of collision, a vehicle posture stability control device for controlling a posture of the vehicle 1 during acceleration or cornering of the vehicle 1, and the like, can be included for a vehicle 1, for example.

In addition to the above, the vehicle 1 can further include a proximity sensor detecting obstacles or other vehicles behind or beside the vehicle 1, a rain sensor detecting whether and how much precipitation has fallen, a wheel speed sensor detecting a speed of a wheel of the vehicle 1, a transverse acceleration sensor detecting a transverse acceleration of the vehicle 1, a yaw rate sensor detecting a change in an angular speed of the vehicle 1, a gyro sensor, a steering angle sensor detecting rotation of the steering wheel 10 of the vehicle 1, and the like, or any combination thereof, for example.

The vehicle 1 can include an electronic control unit (ECU) controlling operation of a power generation device, a power transmission device, a driving device, a steering device, a braking device, a suspension device, a transmission device, a fuel device, various safety devices, and various sensors, for example.

Also, the vehicle 1 can optionally include electronic devices installed for driver convenience, such as a hands-free device, a global positioning system (GPS), an audio device, a Bluetooth device, a rear camera, a terminal charging device, a HI-PASS device (wireless toll payment device), a voice recognition device, or any combination thereof, for example.

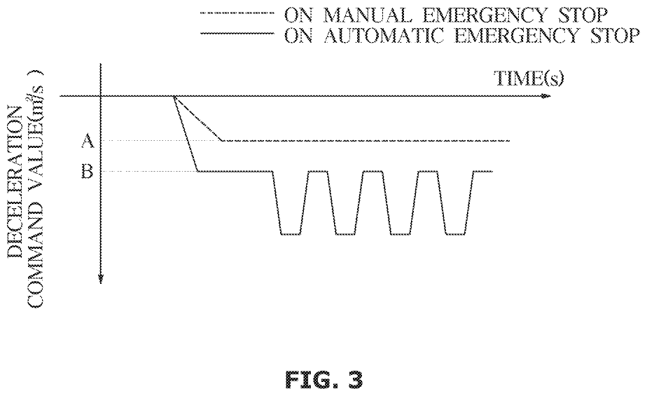

With reference to FIG. 2 and FIG. 3, the vehicle 1 according to an embodiment is described. The vehicle 1 according to an embodiment can include an emergency stop apparatus 100. The emergency stop apparatus 100 can utilize an electronic parking switch of the vehicle 1 to emergency stop the vehicle 1 in an event of emergency. In an embodiment, the emergency stop apparatus 100 of the vehicle 1 includes a front camera 110, a front radar 120, an interior camera 130, a brake controller 140, an I/O device 150, an emergency lamp 160, a switch 170, and a driving controller 180.

The front camera 110 can photograph a front of the vehicle 1. The front camera 110 can photograph the front of the vehicle 1 during autonomous driving. The front camera 110 can then transmit the captured image to the driving controller 180. The front camera 110 can be installed in a position to capture the front of the vehicle 1, such as on top of a front windshield of the vehicle 1.

The front radar 120 can detect an object located in front of the vehicle 1 using radio waves. The front radar 120 can detect another vehicle, pedestrians, bicycles, motorcycles, etc., located in front of the vehicle 1, and also can detect various obstacles.

The interior camera 130 can be installed inside the vehicle 1 to photograph the interior of the vehicle 1, and in particular, to photograph a driver operating the vehicle 1. For example, the interior camera 130 can photograph whether the driver is looking ahead, and whether the driver is holding the steering wheel 10.

The brake controller 140 can control a brake device of the vehicle 1. The brake controller 140 can control the brake device to stop the vehicle 1, when the driver depresses a brake pedal, and when an emergency stop signal is input from the driving controller 180.

As described above, the I/O device 150 can be located inside the vehicle 1 and display various information. In the embodiment, the I/O device 150 can display a notification and warning in an event of emergency requiring an emergency stop, and can also display guidance for the driver or a passenger to take subsequent action.

The emergency lamp 160 can be mounted on an exterior of the vehicle 1 and can be illuminated by operation of an occupant of the vehicle 1 or by control of the driving controller 180. The emergency lamp 160 can be operated to cause all turn signal lamps of the vehicle 1 to flash.

The switch 170 can be mounted inside the vehicle 1. In the embodiment, the switch 170 can be operable to be moved in two directions (one direction and another direction). For example, the switch 170 can be operated by pulling or pushing by an occupant, and be operated to return to its original position when the occupant's external force is removed.

That is, the switch 170 can generate a signal when the occupant pulls with a predetermined external force (in one direction) and can generate a signal when the occupant pushes with a predetermined external force (in the other direction). In addition, the switch 170 can generate separate signals according to a time for generating a signal by pulling and according to a time for generating a signal by pushing. The switch 170 can transmit the generated signal(s) to the driving controller 180.

In the embodiment, a state in which the switch 170 is pulled with a predetermined/programmed external force (in one direction) can be defined as a first input and the state can be maintained for a predetermined/programmed period of time (a) or longer, and a state in which the switch 170 is pushed with a predetermined/programmed external force (in the other direction) can be defined as a second input and the state can be maintained for a predetermined/programmed period of time (b) or longer. The period of time (a) and/or period of time (b) can be selected or calculated, for example. The period of time (a) and/or period of time (b) can be received from another system, for example.

For example, the switch 170 can be an electronic parking brake switch for operating an electronic parking brake device configured to hinder/prevent the vehicle 1 from moving in a parked state.

The driving controller 180 can control various devices to enable normal driving of the vehicle 1 during an autonomous driving mode. The driving controller 180 can control driving of the vehicle 1 using front information of the vehicle 1 based on information and imagery obtained by the front camera 110 and the front radar 120. Also, the driving controller 180 can control the brake controller 140 to slow/stop the vehicle 1, when the vehicle 1 is required/requested/triggered to be braked.

Also, the driving controller 180 can control the I/O device 150 or the display 20 to display a notification, warning, guidance, or any combination thereof, in an event of emergency. The driving controller 180 can control the emergency lamp 160 to flash.

As shown in FIG. 3, when an emergency stop is automatically performed during autonomous driving, the driving controller 180 can transmit a signal to the brake controller 140 to emergency slow/stop the vehicle 1 using brake jerk. When the emergency stop is manually operated during driving, the driving controller 180 can also transmit a signal to the brake controller 140 to slowly decelerate without brake jerk.

In the embodiment, an example where the emergency stop is manually operated is described, and as shown in FIG. 3, a signal can be generated to emergency stop the vehicle 1 with a constant deceleration command value to slowly decelerate without brake jerk. ‘A’ and ‘B’ shown in FIG. 3 are tuning parameters, and an absolute value of A can be set to be less than an absolute value of B (|A|<|B|). That is, a deceleration when the vehicle 1 is manually emergency stopped can be less than a deceleration when the vehicle 1 is automatically emergency stopped.

In an embodiment, when the switch 170 is operated by a passenger and the vehicle 1 is manually emergency stopped, the driving controller 180 can reflect a smaller deceleration than when the emergency stop is automatically performed, because the passenger can notify the emergency. Accordingly, a risk of collision with a rear vehicle while the vehicle 1 is decelerating can be reduced. In addition, because there is less need to call the driver's attention, brake jerk is not applied, thereby reducing the risk of a rear-end collision .

The emergency stop can be automatically activated, when a sustained period of time during which the driver does not hold the steering wheel 10 and/or does not look forward is confirmed by the interior camera 130. The automatically activated emergency stopping can be released when the driver holds the steering wheel 10 or looks ahead again.

Furthermore, in an embodiment, the driving controller 180 can generate a signal for emergency stopping the vehicle 1, in response to the signal generated in the switch 170 by an occupant. For example, the driving controller 180 can generate a notification and warning for emergency stop, when the switch 170 is pulled for a predetermined period of time or longer during driving. Also, the driving controller 180 can control the I/O device 150 or the display 20 to display guidance for emergency stop, when no operation occurs by the driver or occupant.

Here, the operation by the driver or occupant can include operation of the I/O device 150, the switch 170, an accelerator pedal, a brake pedal, and the like, or any combination thereof, performed by the driver or occupant.

Also, in the absence of driver operation (and/or occupant operation), the driving controller 180 can transmit a signal to the brake controller 140 so that the emergency stopping is performed, when the switch 170 is pushed for a predetermined period of time or longer according to guidance to further operate the switch 170.

When the signal for emergency stop is generated in the switch 170, the driving controller 180 can perform an acceleration limit control, until the vehicle 1 completely emergency stopped. That is, the driving controller 180 can control the vehicle 1 not to accelerate, and the brake controller 140 can control the vehicle 1 to decelerate. The acceleration limit control performed by the driving controller 180 can be performed after the first input to the switch 170 occurs until the second input occurs, or after the first input occurs until the driver's operation occurs. The acceleration limit control can be a preliminary control for emergency stopping.

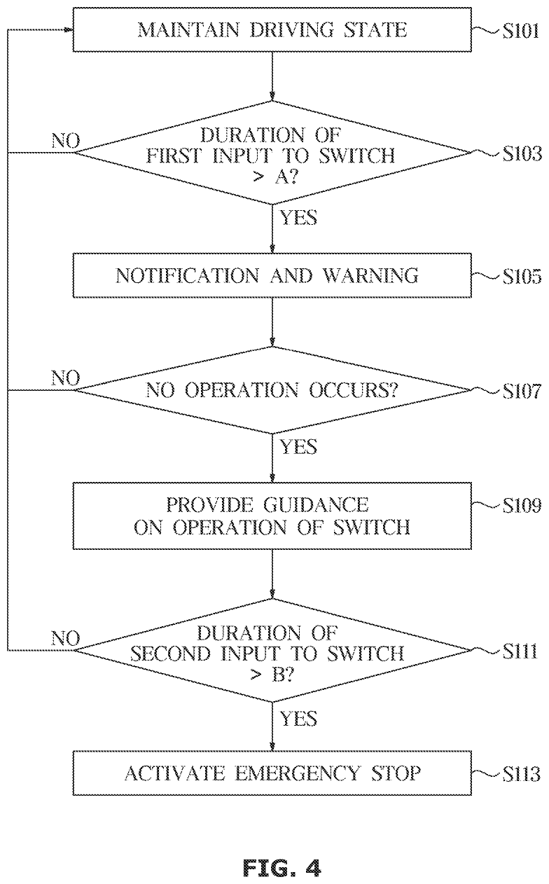

A control method of a vehicle according to an embodiment is described with reference to FIG. 1 to FIG. 4.

The vehicle 1 is maintained in a driving state (operation S101).

That is, a driver maintains the driving state of the vehicle 1. Here, in an embodiment, the vehicle 1 can be maintained in the driving state, even when the driver is unable to hold the steering wheel 10 or is unable to look forward due to an abnormality occurring to the driver while driving. An occupant can be in the vehicle 1 together with the driver.

It can be confirmed whether a duration of a first input to the switch 170 is equal to or greater than a predetermined period of time (a) (operation S103).

In an embodiment, based on an assumption that the driver can no longer keep driving, the switch 170 can be operated by the occupant. However, an embodiment is not necessarily limited thereto, and the switch 170 can be operated by the driver as well.

The occupant can operate the switch 170 as the first input for the predetermined period of time (a) or longer. That is, the occupant can pull the switch 170 for the predetermined period of time (a) or longer. Accordingly, the switch 170 can transmit a signal generated by the first input to the driving controller 180.

When a duration for which the first input to the switch 170 is insufficient or when the first input to the switch 170 is not made, the vehicle 1 can remain in the driving state (e.g., operation S101).

A notification and warning can be generated (operation S105).

When the first input to the switch 170 lasts for the predetermined period of time (a) or longer through operation S103, the notification and/or warning can be generated through the

I/O device 150 and/or the display 20. The notification and warning generated in operation S105 can be for notifying and warning that the vehicle 1 can perform emergency stopping.

In/during operation S105, an acceleration limit control can be performed by the driving controller 180, and the acceleration limit control can be a preliminary control for emergency stopping.

It can be confirmed whether various devices are not operated (operation S107).

In operation S107, whether the driver or occupant is separately operating a device can be confirmed. Here, the operation can include operation of the I/O device 150, the switch 170, an accelerator pedal, a brake pedal, and the like, or any combination thereof, performed by the driver or occupant.

In operation S107, it can be confirmed whether the operation to stop the notification and warning generated in operation S105 is made by the driver or occupant. Accordingly, when the driver or occupant is operating various devices, the vehicle 1 can remain in the driving state (operation S101).

The acceleration limit control performed by the driving controller 180 can end, when the device operation by the driver or occupant occurs, allowing the vehicle 1 to return to a normal driving control. When no device operation by the driver or occupant occurs, the acceleration limit control can be maintained.

Guidance can be provided on an operation of the switch 170 (operation S109).

When it is confirmed that no device operation occurs in operation S107, the driving controller 180 can control the I/O device 150 and/or the display 20 so that guidance on a second input to the switch 170 is provided.

The driving controller 180 can control the I/O device 150 and/or the display 20 to provide guidance to the occupant, so that a second input is made by pushing the switch 170 for a predetermined period of time (b) or longer.

It can be confirmed whether a duration of the second input to the switch 170 is equal to or greater than the predetermined period of time (b) (operation S111).

When the guidance on the second input to the switch 170 is provided through the I/O device 150 and/or the display 20 in operation S109, the second input to the switch 170 can be made by the occupant for predetermined period of time (b) or longer. That is, the occupant pushes the switch 170 for the predetermined period of time (b) or longer, and thus the switch 170 can transmit a signal generated by the second input to the driving controller 180.

When a duration for which the second input to the switch 170 is insufficient or when the second input to the switch 170 is not made, the vehicle 1 can remain in the driving state (operation S101).

When the second input to the switch 170 has been made (e.g., by the occupant) for period of time (b) or longer, emergency stopping is activated (operation S113).

When the second input to the switch 170 lasts for the predetermined period of time (b) or longer in operation S111, the driving controller 180 can transmit a signal for emergency stop to the brake controller 140 to activate the emergency stopping of the vehicle 1.

Because the emergency stop is manually performed, the vehicle 1 can be decelerated at a predetermined acceleration, and can decelerate slowly without brake jerk due to the manual emergency stop.

According to an embodiment of the disclosure, a passenger can manually emergency stop a vehicle with a switch, enabling a safe emergency stop of the vehicle, even when the vehicle is not automatically emergency stopped.

By operating the switch in a redundant manner, for example, the vehicle can be safely emergency stopped without accidental emergency stop against a will of a driver or an occupant.

Although embodiments have been described for illustrative purposes, those skilled in the art can appreciate that various modifications, additions, and substitutions can be possible, without departing from the scope and spirit of the disclosure. Therefore, embodiments have not been described for limiting purposes.

What is claimed is:

1. A vehicle, comprising:
a switch configured to generate a signal for the vehicle to perform emergency stopping during driving; and
a driving controller configured to control the vehicle to perform the emergency stopping in response to the signal generated by the switch;
wherein the signal comprises a first signal generated in response to a first input to the switch; and
wherein the signal further comprises a second signal generated in response to a second input to the switch, the second input being different from the first input.

2. The vehicle of claim 1, wherein the driving controller is configured to control the vehicle to perform the emergency stopping, in response to the first input to the switch lasting longer than a first period of time and in response to the second input to the switch lasting longer than a second period of time.

3. The vehicle of claim 1, further comprising an input-output device configured to display information about the vehicle.

4. The vehicle of claim 3, wherein the driving controller is configured to control the input-output device to display a notification that the vehicle is to be emergency stopped, in response to the first signal.

5. The vehicle of claim 3, wherein the driving controller is configured to control the input-output device to provide guidance on the second input, in response to the first signal.

6. The vehicle of claim 1, wherein the switch is configured to move in a first direction relative to a center position, wherein the switch is configured to move in second direction relative to the center position, the second direction being different than the first direction, and wherein the switch is configured to be biased towards the center position.

7. The vehicle of claim 6, wherein the switch is configured to generate the first signal in response to the first input to the switch physically moving the switch in the first direction, and wherein the switch is configured to generate the second signal in response to the second input to the switch physically moving the switch in the second direction.

8. The vehicle of claim 1, wherein the switch is an electronic parking brake switch.

9. The vehicle of claim 1, wherein the driving controller is configured to confirm whether a device included in the vehicle is not operated after the first input to the switch lasts for a first period of time, and control the vehicle to perform the emergency stopping, in response to the second input to the switch lasting for a second period of time.

10. The vehicle of claim 1, wherein the driving controller is configured to control the vehicle not to perform the emergency stopping, in response to a device included in the vehicle being operated during the second input to the switch.

11. The vehicle of claim 1, wherein the driving controller is configured to perform an acceleration limit control in response to the first input to the switch.

12. A control method of a vehicle, the control method comprising:
confirming whether a first input to a switch is made while the vehicle is driving;
generating a notification of emergency stopping in response to the first input to the switch;
confirming whether a second input is made to the switch, the second input being different than the first input; and
generating a signal for the vehicle to perform emergency stopping in a driving controller in response to the second input to the switch.

13. The control method of claim 12, wherein confirming whether the first input is made further comprises confirming whether the first input to the switch lasts longer than a first period of time.

14. The control method of claim 12, wherein confirming whether the second input is made further comprises confirming whether the second input to the switch lasts longer than a second period of time.

15. The control method of claim 12, further comprising confirming whether a device included in the vehicle is not operated during the generating the notification, wherein the confirming of whether the second input is made only if the device is not being operated.

16. The control method of claim 15, further comprising providing guidance for operating the switch for the second input, in response to the device not being operated.

17. The control method of claim 15, wherein performing the emergency stopping is discontinued in response to the device being operated.

18. The control method of claim 12, wherein the switch is configured to move in first direction and in second direction, the second direction being different than the first direction.

19. The control method of claim 18, wherein the switch is configured to physically move in the first direction in response to the first input, and wherein the switch is configured to physically move in the second direction in response to the second input.

20. The control method of claim 12, wherein the switch is an electronic parking brake switch.
